(19) United States
(12) Patent Application Publication
(10) Pub. No.: US 2018/0370494 A1
(43) Pub. Date: Dec. 27, 2018

(54) REAR WIPER AND METHOD OF FORMING THE SAME

(71) Applicant: Ford Global Technologies, LLC, Dearborn, MI (US)

(72) Inventors: Geoffrey Johnson, Taylor, MI (US); Jose Garcia Crespo, Bloomfield Township, MI (US); Brad Napier Doman, Ann Arbor, MI (US)

(21) Appl. No.: 15/632,483

(22) Filed: Jun. 26, 2017

(51) Int. Cl. B60S 1/38; B62D 29/00

(52) U.S. Cl. CPC B60S 1/3808; B60S 1/381; B60S 2001/3827; B60S 1/3848; B62D 29/001

(57) ABSTRACT

A rear wiper for a motor vehicle according to an exemplary aspect of the present disclosure includes, among other things, a wiper arm including an overmolded metallic bar. This disclosure also relates to a motor vehicle including the rear wiper, and a method of forming the rear wiper.

### BACKGROUND

This disclosure relates to a rear wiper for a motor vehicle and a method of forming the same.

Motor vehicles are known to have a rear window formed as part of a rear closure. In sport utility vehicles (SUVs), hatchbacks, and minivans, as examples, rear windows commonly include a rear wiper configured to traverse across the rear window to clear water and debris.

### SUMMARY

A rear wiper for a motor vehicle according to an exemplary aspect of the present disclosure includes, among other things, a wiper arm including an overmolded metallic bar.

In a further non-limiting embodiment of the foregoing rear wiper, the metallic bar is curved along its length when in a resting condition, and the metallic bar is biased toward the resting condition.

In a further non-limiting embodiment of any of the foregoing rear wipers, a first end of the wiper arm includes a first connector configured to connect the wiper arm to a wiper blade.

In a further non-limiting embodiment of any of the foregoing rear wipers, the first metallic connector is a pin.

In a further non-limiting embodiment of any of the foregoing rear wipers, a second end of the wiper arm opposite the first end includes a second connector configured to connect the wiper arm to a rotatable shaft, the second connector is made of a metallic material, and the wiper arm is provided by an overmolding including the metallic bar and the second connector.

In a further non-limiting embodiment of any of the foregoing rear wipers, the second metallic connector includes grooves configured to engage splines of the rotatable shaft.

In a further non-limiting embodiment of any of the foregoing rear wipers, the metallic arm is overmolded with a polymer material.

In a further non-limiting embodiment of any of the foregoing rear wipers, the polymer material includes 10% to 50% glass fibers by weight.

In a further non-limiting embodiment of any of the foregoing rear wipers, the polymer material is polybutylene terephthalate.

In a further non-limiting embodiment of any of the foregoing rear wipers, the metallic bar is made of aluminum.

In a further non-limiting embodiment of any of the foregoing rear wipers, the rear wiper is configured to wipe a rear window of the motor vehicle.

A motor vehicle according to an exemplary aspect of the present disclosure includes, among other things, a rear window and a wiper configured to wipe the rear window. The wiper including a wiper arm having an overmolded metallic bar, and the metallic bar biases the wiper against the rear window.

In a further non-limiting embodiment of the foregoing motor vehicle, the metallic bar is formed with a curve along its length when in a resting condition, and contact between the wiper and the rear window moves the metallic bar from the resting condition.

In a further non-limiting embodiment of any of the foregoing motor vehicles, the vehicle further comprises a rotatable shaft configured to rotate the wiper relative to the rear window. Further, the wiper arm includes a first connector, the first connector is made of a metallic material, and the wiper arm is provided by an overmolding including the metallic bar and the first connector. The first connector is connected to the rotatable shaft.

In a further non-limiting embodiment of any of the foregoing motor vehicles, the wiper includes a wiper blade connected to a second connector of the wiper arm.

In a further non-limiting embodiment of any of the foregoing motor vehicles, the movement of the metallic bar from the resting position causes the wiper to exert a load of about 18 grams-force per centimeter of length of the wiper blade onto the rear window.

In a further non-limiting embodiment of any of the foregoing motor vehicles, the metallic arm is overmolded with polybutylene terephthalate including 10% to 50% glass fibers by weight.

A method according to an exemplary aspect of the present disclosure includes, among other things, forming a wiper arm by overmolding a metallic bar.

In a further non-limiting embodiment of the foregoing method, the metallic bar is rolled provide the metallic bar with a curve along its length.

In a further non-limiting embodiment of any of the foregoing methods, the wiper arm is formed by overmolding the metallic bar and a connector for connecting the wiper arm to a rotatable shaft.

### BRIEF DESCRIPTION OF THE DRAWINGS

FIG. 1 is a rear-perspective view of a motor vehicle including a rear wiper.

FIG. 2 illustrates an example rear wiper.

FIG. 3 illustrates the detail of a connector between a wiper arm and a wiper head.

FIG. 4 is a flow chart representative of an example method of forming a rear wiper.

### DETAILED DESCRIPTION

This disclosure relates to a rear wiper for a motor vehicle and a method of forming the same. In this disclosure, the rear wiper includes a wiper arm including an overmolded metallic bar. The metallic bar is a spring-loaded bar, and biases the wiper arm against a rear window of the vehicle. Thus, the wiper arm is provided by a single, overmolded component, which reduces the number of components in the wiper arm. In turn, this leads to reduced cost and increased ease of manufacture and assembly.

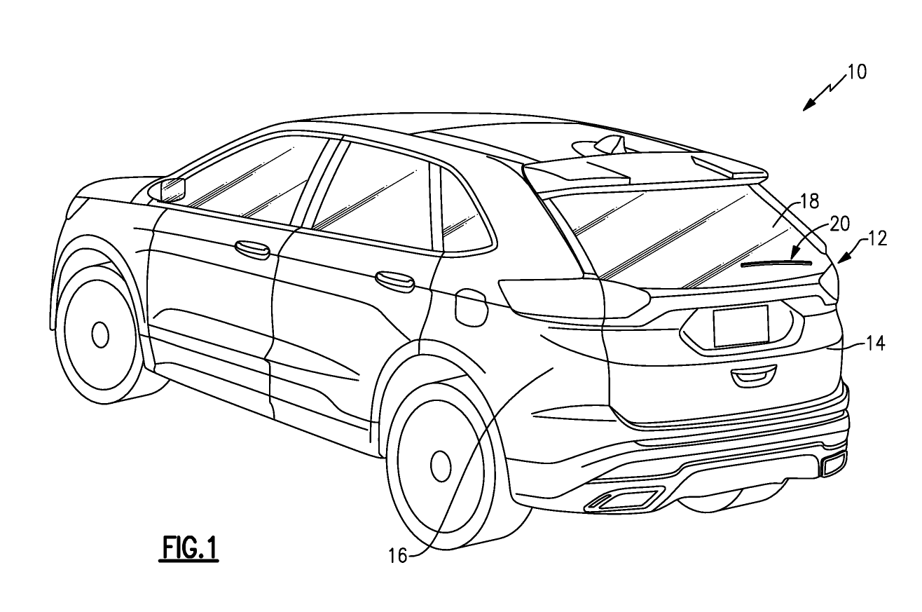

Referring to the drawings, FIG. 1 is a rear-perspective view of a motor vehicle 10, which is shown as a sport utility vehicle (SUV), including a liftgate assembly 12. While FIG. 1 shows an SUV, this disclosure is not limited to SUVs and extends to other vehicles, including minivans and hatchbacks, among others.

In this example, the liftgate assembly 12 includes a liftgate 14 rotatable between a fully open position and a closed position to selectively open and close (respectively) an opening defined in a rear of a vehicle body 16. The liftgate 14 is pivotally mounted to the vehicle body 16 near an upper edge of the liftgate 14. As used in this disclosure, the vehicle body 16 refers to the frame (including pillars) and paneling of the vehicle 10.

The liftgate assembly 12 also includes a rear window 18, which in this example is a flipglass window. The rear window 18, in this example, is rotatable between a fully open and closed position to selectively expose a portion of the opening defined in the rear of the vehicle body 16. Like the liftgate 14, the rear window 18 is pivotally mounted to the vehicle body 16 near an upper edge of the rear window 18. While a flipglass window is shown in FIG. 1, it should be understood that this disclosure extends to vehicles that do not include flipglass windows. For example, the vehicle 10 could include a rear window 18 that is fixed relative to the liftgate 14 or the vehicle body 16, as examples.

The vehicle 10 includes a rear wiper 20 configured to traverse the rear window 18 and clear water, ice, snow, and other debris therefrom. With reference to FIG. 2, the wiper 20 includes a wiper arm 22, a wiper head 24 connected to the wiper arm 22, and wiper blade 26 connected to the wiper head 24. It should be understood that certain aspects of the wiper 20 are exaggerated in the Figures for purposes of illustration only.

The wiper arm 22 has a first end 28 configured to connect to a rotatable shaft, which is configured to rotate the wiper 20. The wiper arm 22 further includes a second end 30, which is opposite the first end 28 and is connected to the wiper head 24 by way of a connector 32.

In this disclosure, the wiper arm 22 is provided by a single, overmolded component. Overmolding is the process of adding material over already-existing pieces or parts using a molding process. The result is an integrated component including the original piece or pieces and the additional material added via the overmolding process.

The wiper arm 22 in this disclosure is provided by overmolding at least one already-existing component. In particular, the wiper arm 22 includes an overmolded metallic bar 34. The metallic bar 34 is formed such that it is curved along its length. Thus, when in a resting condition in which no outside forces are applied to the metallic bar 34, the metallic bar 34 exhibits a curvature. In this example, the metallic bar 34 has a generally rectangular cross-section. In another example, the metallic bar 34 is not rectangular in cross-section. For example, the metallic bar 34 can be provided by a structure such as “music wire” or “piano wire,” which is made of a tempered high-carbon steel, also known as spring steel.

FIG. 2 shows the metallic bar 34 in a resting condition. In FIG. 2, the metallic bar 34 is curved following a constant radius of curvature R having an origin O on a side of the wiper 22 that will contact the rear window 18 of the vehicle 10. In FIG. 2, the wiper blade 26 is between the origin O and the wiper arm 22. This disclosure is not limited to metallic bars having a constant radius of curvature, and extends to other wiper arms with metallic bars curved toward the rear window of a vehicle.

When the wiper 20 is mounted to the vehicle 10, the rear window 18 will directly contact the wiper blade 26 and move the wiper arm 22 in a direction D₁ away from the rear window 18. In one example, the rear window moves the wiper arm 22 such that the metallic bar 34 is substantially straight and is no longer in the resting condition of FIG. 2. The bias of the metallic bar 34 toward the resting condition, however, urges the wiper arm 22, and in turn the wiper blade 26, in the direction D₂ toward the rear window 18.

The bias of the metallic bar 34 provides direct contact between the wiper blade 26 and the rear window 18 sufficient to allow the wiper 20 to adequately clear the rear window 18. In one example, the metallic bar 34 is arranged such that the wiper 20 exerts a load of about 18 grams-force (about 0.04 lbf) per centimeter of length of the wiper blade 26 onto the rear window 18.

In one example, the metallic bar 34 is made of aluminum. This disclosure extends to other material types, however, including other metallic or non-metallic materials. In the same example, the remainder of the wiper arm 22, labeled at 36, is provided by a polymer material. Specifically, the polymer material may be polybutylene terephthalate (sometimes abbreviated as PBT). The polymer material may alternatively or additionally be a fiber-reinforced polymer material including between 10-50% glass fibers by weight.

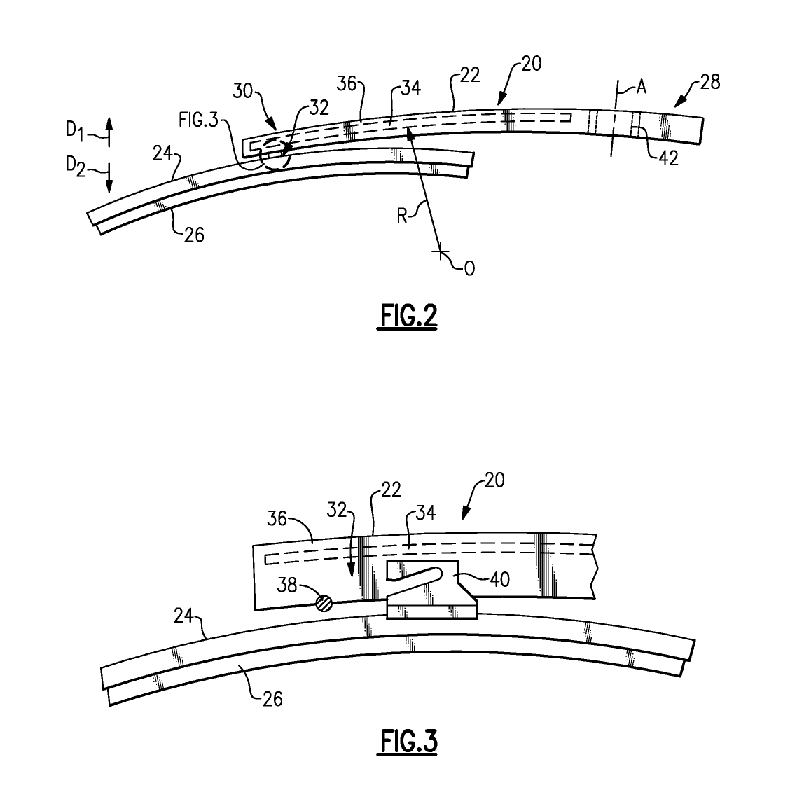

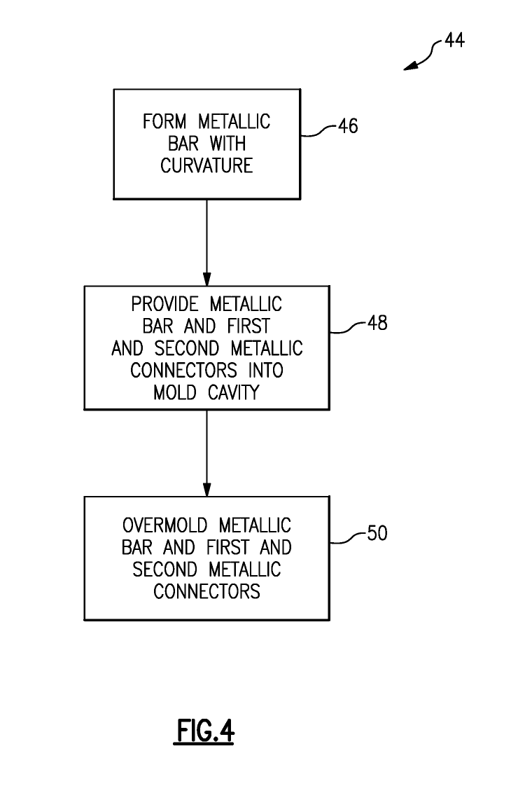

In the embodiment of FIG. 2, the wiper arm 22 is overmolded with two additional already-existing components in addition to the metallic bar 34. In particular, as shown in FIG. 3, the wiper arm 22 includes a first connector 38 configured to connect the wiper arm 22 to the wiper head 24, and in turn the wiper blade 26. The first connector 38 is a pin in this example, and may be made of plastic and formed during the overmolding process. Alternatively, the first connector 38 may be made of a metallic material and may be overmolded.

The first connector 38 is configured to connect to the wiper head 24 by way of a slotted connector 40. The slotted connector 40 may be formed of plastic, or may be a metallic material. Together, the first connector 38 and the slotted connector 40 provide the connector 32. The slotted connector 40 may include a detent or clip, as examples, configured to maintain engagement with the first connector 38. It should be understood that this disclosure is not limited to the details of the first connector 38 and the slotted connector 40. Further, it should be understood that the slotted connector 40 could be incorporated into the wiper arm 22, and the wiper head 24 could include a pin.

The wiper arm 22 of FIG. 2 is also overmolded with a second connector 42 configured to connect the wiper arm 22 to a rotatable shaft of an actuator, which is configured to rotate the wiper 20. The rotatable shaft may be mounted to the vehicle 10 in a location adjacent the rear window 18. The second connector 42 is generally cylindrical with a central bore configured to engage the rotatable shaft, and is defined about an axis A. The axis A is substantially normal to the length of the wiper arm 22 and the length of the metallic bar 34. The second connector 42 may be made of a metallic material, and may include features configured to engage the rotatable shaft. In one example, the rotatable shaft includes splines, and the second connector 42 includes grooves configured to receive the splines.

While in this disclosure the wiper arm 22 is provided by an overmolding of three already-existing pieces, it should be understood that the wiper arm 22 could be provided by an overmolding including only the metallic bar 34. The wiper arm 22 could alternatively be integrally formed with the wiper head 24, for example, eliminating the need for the first connector 38. Further, the wiper arm 22 could be connected to the rotating shaft without using a second connector 42.

FIG. 4 is a flow chart illustrating an example method 44 of forming the wiper arm 22. As generally noted above, the wiper arm 22 is formed by overmolding the wiper arm 22 with at least one already-existing piece. In the embodiment of FIG. 2, the wiper arm 22 is formed by overmolding the metallic bar 34, the first connector 38, and the second connector 42.

The metallic bar 34 provides the wiper arm 22, and in turn the wiper 20, with a bias toward the resting condition of the metallic bar 34. In the method 44, the metallic bar 44 is formed with a curvature, at 46. In one example, the metallic bar 34 is rolled to provide the metallic bar 34 with the curvature. The curvature of the metallic bar 34 causes the wiper 20 to exert an appropriate level of force on the rear window 18.

At 48, the metallic bar 34, first connector 38, and second connector 42 are provided into a molding cavity. The molding cavity is shaped to correspond to the shape of the wiper arm 22. At 50, the metallic bar 34, first connector 38, and second connector 42 are overmolded with the material providing the remainder 36 of the wiper arm 22 using an injection molding process, for example. As noted above, the overmolding material may be a polymer material. As the polymer cools within the mold cavity, it adheres to the metallic bar 34, first connector 38, and second connector 42 to provide a single, overmolded component with a shape corresponding to the shape illustrated in FIG. 2, for example. While one example method 44 has been described herein, this disclosure extends to other methods of forming the wiper arm 22. In particular, as noted above, the wiper arm 22 may exclude the first connector 38 and the second connector 42.

It should be understood that terms such as “about,” “substantially,” and “generally” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A rear wiper for a motor vehicle, comprising:
a wiper arm including an overmolded metallic bar.

2. The rear wiper as recited in claim 1, wherein the metallic bar is curved along its length when in a resting condition, and wherein the metallic bar is biased toward the resting condition.

3. The rear wiper as recited in claim 1, wherein a first end of the wiper arm includes a first connector configured to connect the wiper arm to a wiper blade.

4. The rear wiper as recited in claim 3, wherein the first connector is a pin.

5. The rear wiper as recited in claim 3, wherein a second end of the wiper arm opposite the first end includes a second connector configured to connect the wiper arm to a rotatable shaft, the second connector made of a metallic material, the wiper arm provided by an overmolding including the metallic bar and the second connector.

6. The rear wiper as recited in claim 5, wherein the second connector includes grooves configured to engage splines of the rotatable shaft.

7. The rear wiper as recited in claim 1, wherein the metallic arm is overmolded with a polymer material.

8. The rear wiper as recited in claim 7, wherein the polymer material includes 10% to 50% glass fibers by weight.

9. The rear wiper as recited in claim 7, wherein the polymer material is polybutylene terephthalate.

10. The rear wiper as recited in claim 7, wherein the metallic bar is made of aluminum.

11. The rear wiper as recited in claim 1, wherein the rear wiper is configured to wipe a rear window of the motor vehicle.

12. A motor vehicle, comprising:
a rear window; and
a wiper configured to wipe the rear window, the wiper including a wiper arm having an overmolded metallic bar, wherein the metallic bar biases the wiper against the rear window.

13. The motor vehicle as recited in claim 12, wherein the metallic bar is formed with a curve along its length when in a resting condition, and wherein contact between the wiper and the rear window moves the metallic bar from the resting condition.

14. The motor vehicle as recited in claim 12, further comprising a rotatable shaft configured to rotate the wiper relative to the rear window, the wiper arm including a first connector, the first connector made of a metallic material, the wiper arm provided by an overmolding including the metallic bar and the first connector, the first connector connected to the rotatable shaft.

15. The motor vehicle as recited in claim 14, wherein the wiper includes a wiper blade connected to a second connector of the wiper arm.

16. The motor vehicle as recited in claim 15, wherein the movement of the metallic bar from the resting position causes the wiper to exert a load of about 18 grams-force per centimeter of length of the wiper blade onto the rear window.

17. The motor vehicle as recited in claim 12, wherein the metallic arm is overmolded with polybutylene terephthalate including 10% to 50% glass fibers by weight.

18. A method, comprising:
forming a wiper arm by overmolding a metallic bar.

19. The method as recited in claim 18, wherein the metallic bar is rolled provide the metallic bar with a curve along its length.

20. The method as recited in claim 18, wherein the wiper arm is formed by overmolding the metallic bar and a connector for connecting the wiper arm to a rotatable shaft.
